(19) United States
(12) Patent Application Publication
(10) Pub. No.: US 2018/0048129 A1
(43) Pub. Date: Feb. 15, 2018

(54) APPARATUS FOR MANAGING ELECTRICAL WIRES

(71) Applicant: Jerry WALSH, Stratford (CA)

(72) Inventor: Jerry WALSH, Stratford (CA)

(21) Appl. No.: 15/672,836

(22) Filed: Aug. 9, 2017

Related U.S. Application Data
(60) Provisional application No. 62/372,943, filed on Aug. 10, 2016.

(51) Int. Cl. H02B 1/42; H02G 3/38; H02G 3/08

(52) U.S. Cl. CPC H02B 1/42; H02G 3/083; H02G 3/288; H02G 3/263

(57) ABSTRACT

The disclosure is directed at an apparatus for managing wires in a home. The apparatus includes a surface mount manager mounted between two studs of a house frame for receiving and spacing electrical cables. The apparatus further includes a recessed manager bracket that is also mounted to the two studs for receiving the electrical cables from the surface mount manager and a wire manager plate apparatus mounted to the two studs for receiving the electrical cables from the recessed manager bracket, the wire manager plate including a set of wire manager holes for receiving the electrical cables and having an axis perpendicular to the length of the two studs.

### CROSS-REFERENCE TO OTHER APPLICATIONS

This application claims priority from U.S. Provisional Application No. 62/372,943 filed Aug. 10, 2016, which is hereby incorporated by reference.

### FIELD OF THE DISCLOSURE

The disclosure is directed generally to electrical wiring, and more specifically, at an apparatus for managing electrical wires.

### BACKGROUND OF THE DISCLOSURE

With the importance or energy conservation in residential homes, maintaining insulation R-value is extremely important on exterior walls.

Electrical load centers that are mounted on an exterior wall typically conflict with the branch circuits in the stud cavity and insulation interference. Several branch circuits coming together in a wall cavity become cumbersome and it is challenging to maintain spacing to allow for insulation material to be installed. The same problem applies to communication cables.

Therefore, there is provided a novel apparatus for managing electrical wires.

### SUMMARY OF THE DISCLOSURE

The disclosure is directed at an apparatus for managing electrical wires. The apparatus can also be seen as a wire manager. The apparatus includes a wire manager plate that can be recessed into a stud wall adjacent to an electrical load center or a main communication port. In one embodiment, the wire manager plate is a vapor proof plate. The wire manager plate is preferably mounted to the stud wall via a set of metal brackets that allow adjustments for the thickness of a wall board.

In one aspect, there is provided apparatus for managing wiring within a frame of a building, the building including at least two studs within the frame, the apparatus including a surface mount manager mounted to and between the at least two studs for receiving and spacing electrical cables, the surface mount manager including a set of surface mount manager holes for receiving the electrical cables, the set of surface mount manager holes having an axis parallel to a length of the at least two studs; a recessed manager bracket mounted to and between the at least two studs for receiving the electrical cables from the surface mount manager, the recessed manager bracket including a set of recessed manager bracket holes for receiving the electrical cables, the set of recessed manager bracket holes having an axis parallel to a length of the at least two studs; and a wire manager plate apparatus mounted to and between the at least two studs for receiving the electrical cables from the recessed manager bracket, the wire manager plate including a set of wire manager holes for receiving the electrical cables, the set of wire manager plate holes having an axis perpendicular to the length of the at least two studs.

In another aspect, the wire manager plate apparatus comprises an apparatus for managing electrical wiring includes a wire manager plate including a set of holes for receiving different groupings of electrical wiring; and a mounting plate including a mounting mechanism for mounting the apparatus to a front of a wall cavity; wherein the wire manager plate is integrated within the mounting plate. In a further aspect, the mounting plate forms a lip portion around the wire manager plate. In yet another aspect, the wire manager plate apparatus further includes a gasket portion affixed to the lip portion. In an aspect, the gasket portion is made from foam. In another aspect, the wire manager plate apparatus includes fastener holes.

### DESCRIPTION OF THE DRAWINGS

The advantages and features of wire manager will become better understood when viewing the different figures and descriptions appointed to the various points

FIG. 1a is a perspective view of the recessed vapor proof plate manager with all its features;

FIG. 1b is a perspective view of the trim ring and gasket seal;

FIG. 2a is a perspective view of the recessed manager bracket with its supports attached for mounting;

FIG. 2b is a perspective view of the mounting brackets required for mounting;

FIG. 3 is a perspective view of the surface manager bracket with its features;

FIGS. 4a to 4l are photographs showing various views of an apparatus for managing electrical wires; and

FIG. 4m is a photograph of a plate for use with the apparatus for managing electrical wires.

### DETAILED DESCRIPTION

The disclosure is directed at an apparatus for managing electrical wires or wiring. In one embodiment, the apparatus includes a wire manager plate and a set of mounting brackets that allow the apparatus to be mounted to a wall, such as a stud wall or between two studs of a housing frame. The apparatus of the disclosure allows for electrical wires, such as branch circuits, to be installed to the front of a wall cavity. The apparatus supports the wires and are spaced allowing for insulation batt to be installed behind the apparatus and against an exterior wall.

Example embodiments are described below. It will be understood that the dimensions detailed below are illustrative of this embodiment and may be varied depending on the cables being managed, the spacing in the wall, the studs pattern, and the like.

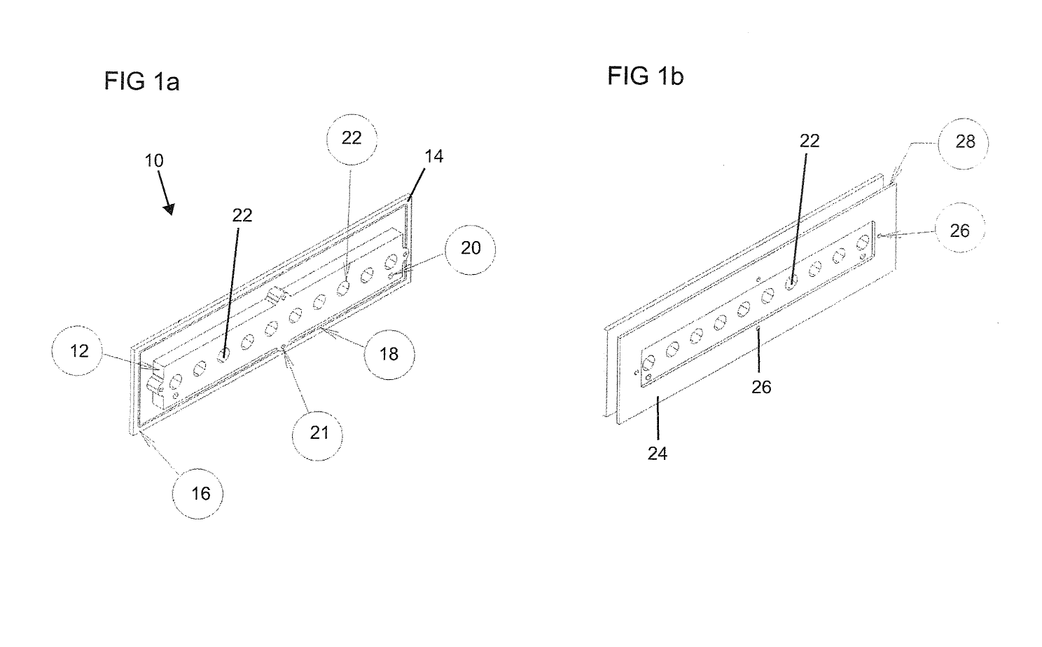

Turning to FIG. 1a, a front perspective view of a first embodiment of apparatus for managing electrical wires or wiring is shown. The apparatus can also be used for managing electrical cables.

The apparatus 10 includes a wire manager plate 12 that is housed within a rear plate or housing 14. The housing 14 includes a lip portion 16, that is preferably a milled surface that surrounds the plate 12. The apparatus 10 further includes a gasket portion 18 (preferably made of foam) that is mounted to the lip portion 16 to assist in forming an air seal such that when the apparatus 10 is installed up against the back of a wall board, an air tight seal is formed between the apparatus 10 and the wall board to reduce or eliminate drafts. The gasket portion 18 may be seen as an air barrier. The apparatus 10 further includes a set of fastener holes 20 for receiving fasteners to fasten or mount the apparatus 10 along with a set of plate mounting holes 21.

The wire manager plate 12 includes a set of wire management holes 22 for receiving the electrical wires (not shown). In the current embodiment, the wire manager pate 12 includes ten wire management holes 22 that are spaced equal distance apart allowing a cable width distance for air movement to meet known electrical codes. Heating factors of power cables are a concern if the cables touch one another as there is limited air movement, therefore cable separation may be important.

Turning to FIG. 1b, a perspective view of the apparatus of FIG. 1a with a front plate is shown. As can be seen in the current embodiment, the apparatus 10 further includes a front plate 24 that is located adjacent a front face of the wire manager plate 12. The front plate 24 includes a set of holes 26 for receiving fasteners for mounting the front plate 24 to the wire manager plate. In a preferred embodiment, the set of holes 26 within the front plate 24 align with the plate mounting holes 21 within the wire manager plate 12. Surrounding the front plate 24 is preferably a gasket material 28 (such as foam). The gasket material 28 may provide a barrier to stop an air draft in the event a breach occurs in the installation of the apparatus 10.

When the apparatus 10 is being installed and the gasket portion 18 (or air barrier) is applied before the wall board, the gasket portion 18 preferably presses up against the foam in a manner that reduces or minimizes a breach in the air barrier causing drafts. In a preferred embodiment, the thickness of the gasket portion 18 is between 1 mm and 3 mm, and more preferably 2 mm, such that there is adequate compression when the wall board is pressed up to the apparatus 10. For a gasket portion of 2 mm, the thickness of the lip portion 16 is preferably 5 mm. This allows the wire manager plate 12 to be rigid and robust and preferably able to withstand the weight of the cables or wiring during installation of the branch circuits.

In one embodiment, the diameter of the holes 22 is selected such that all sizes of cables that are used for residential dwellings can pass through the hole without causing damage to the outer sheath. For the holes 22 that are not used during installation, these holes may be covered with foam material.

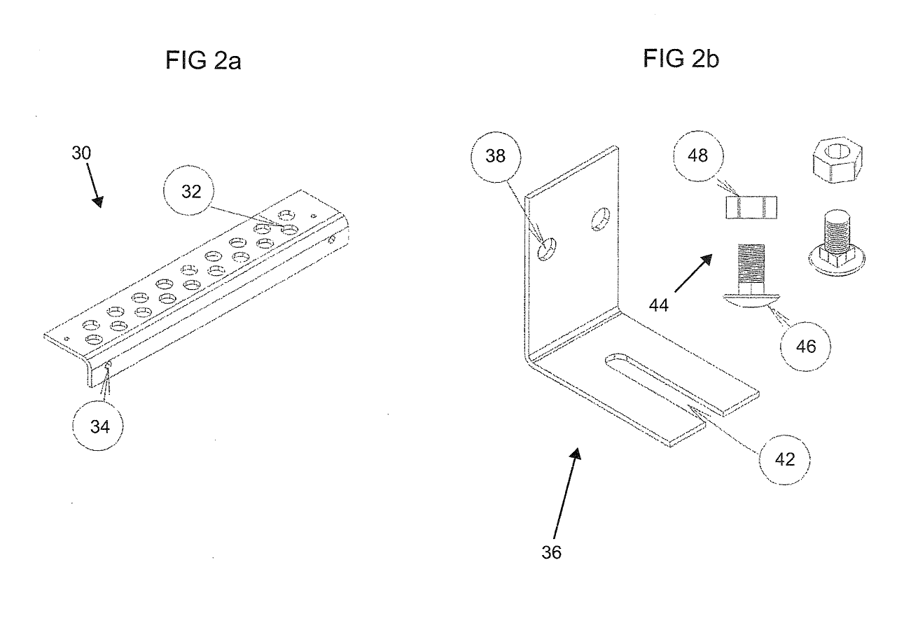

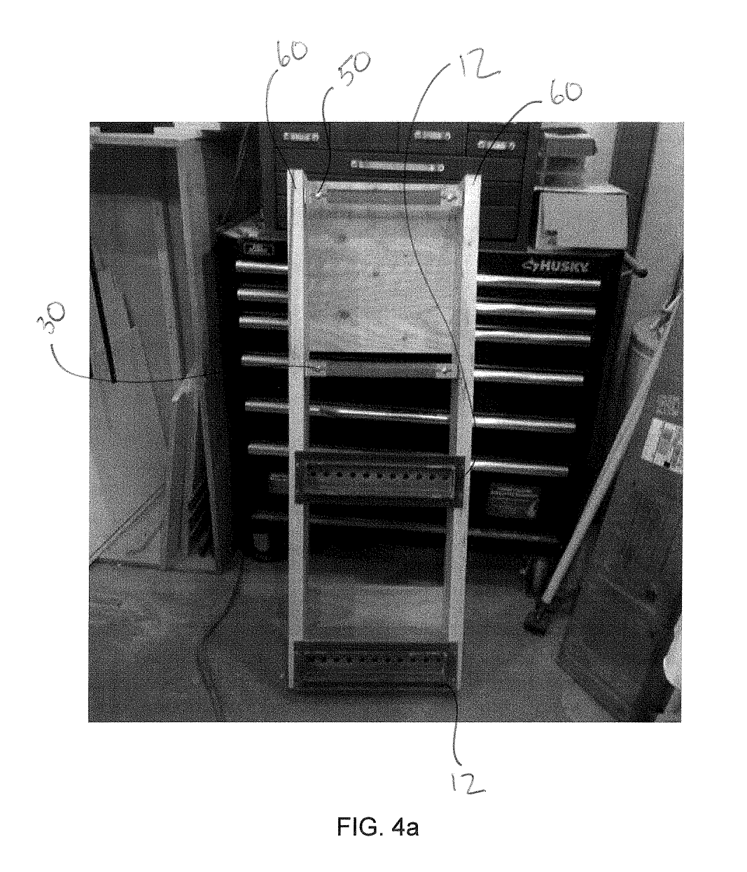

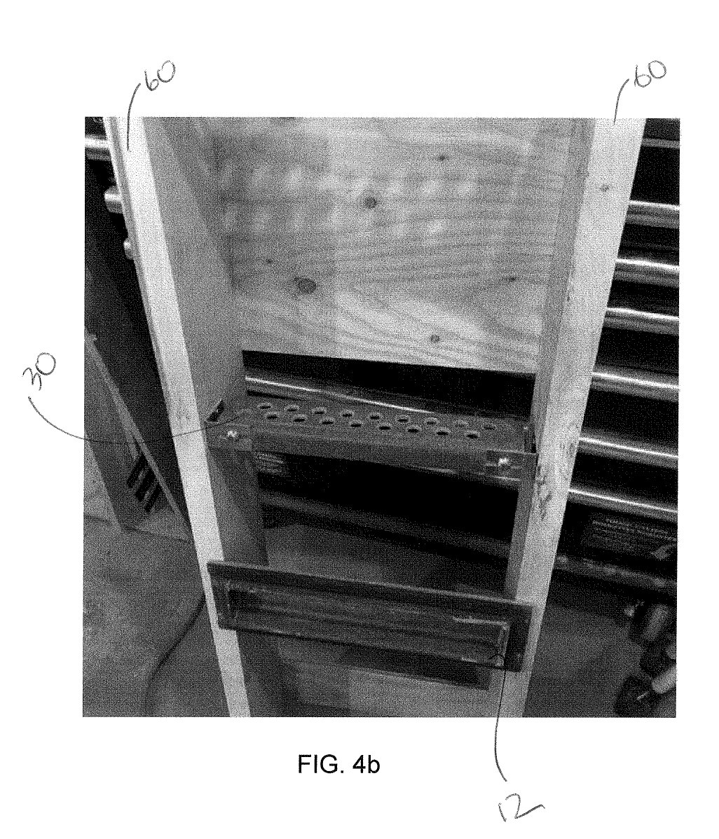

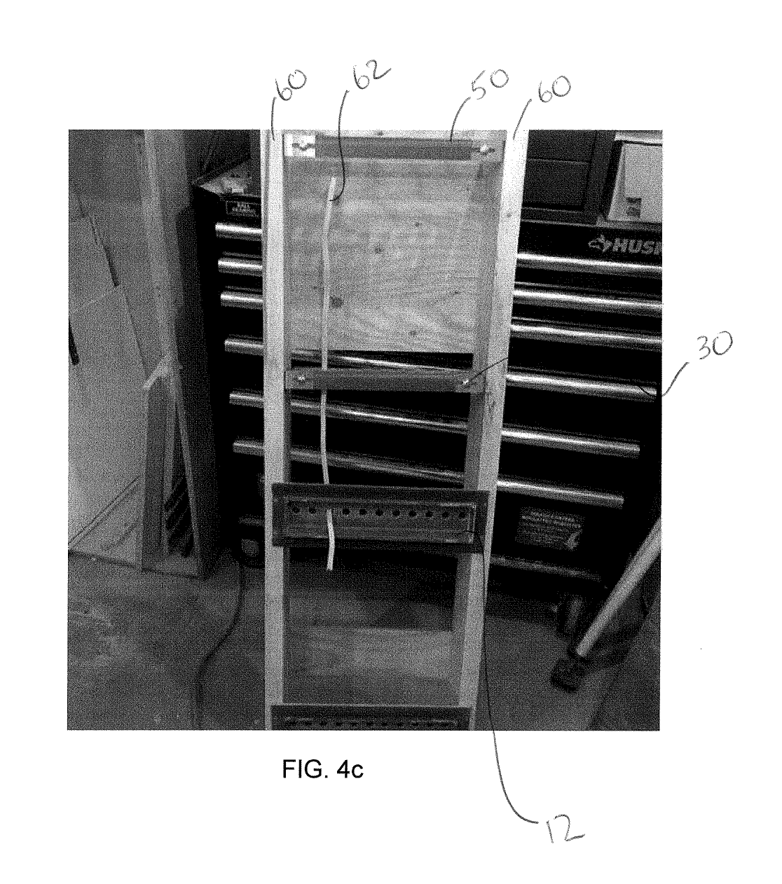

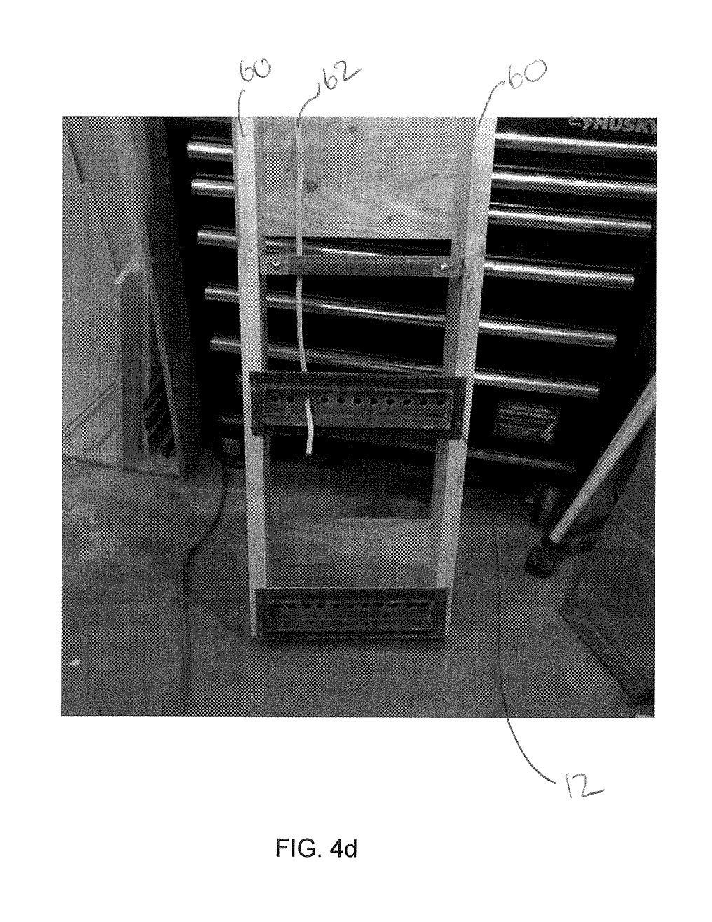

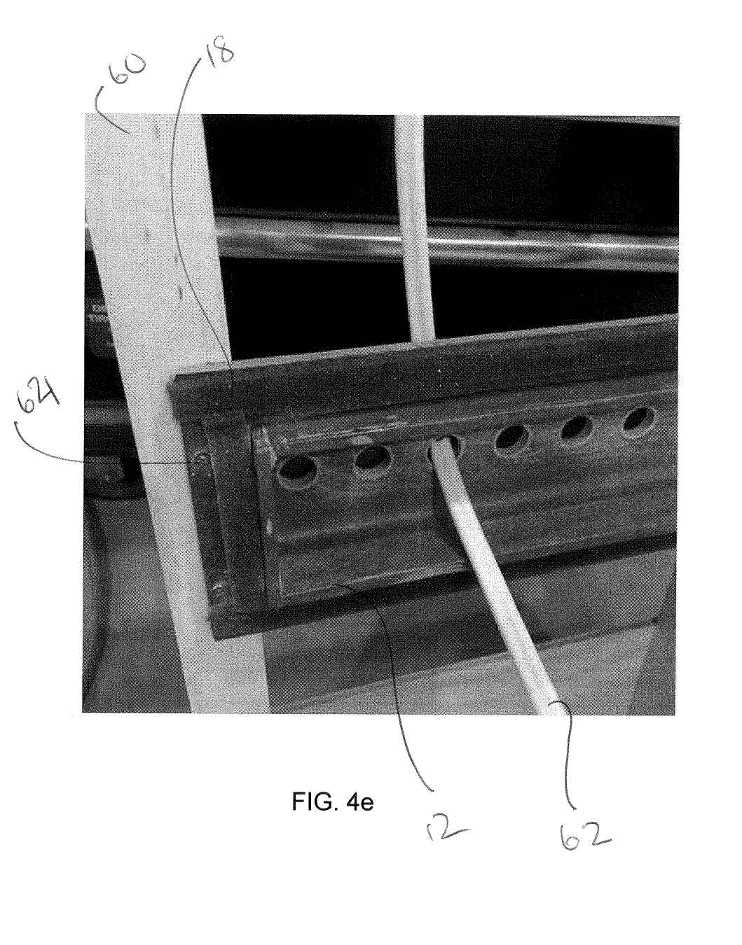

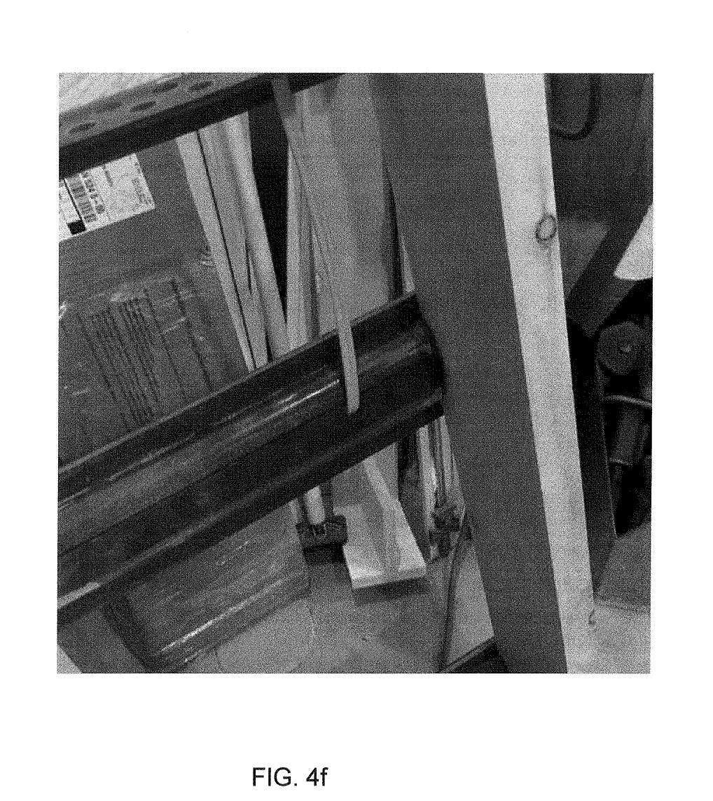

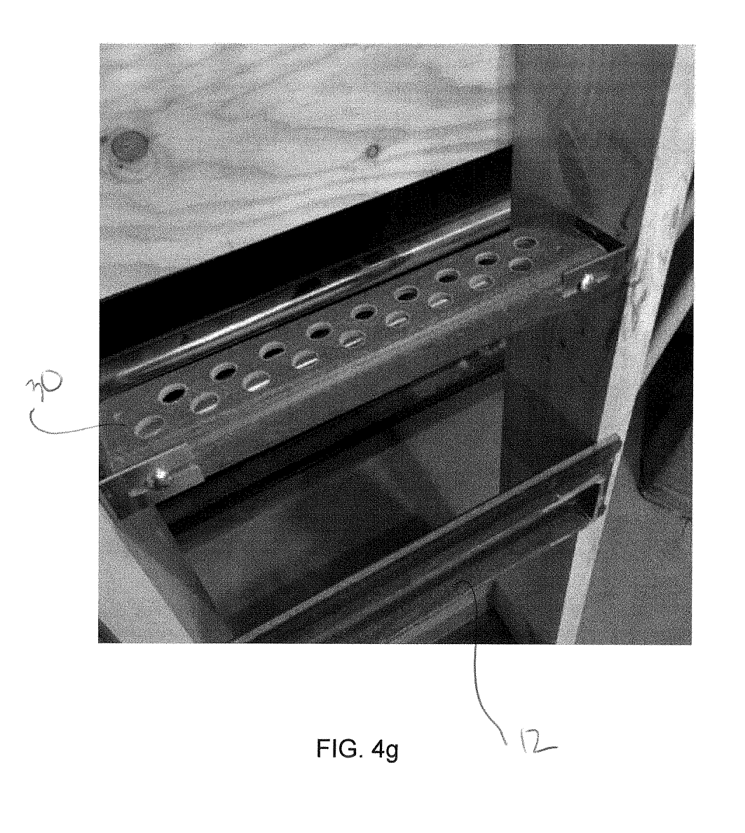

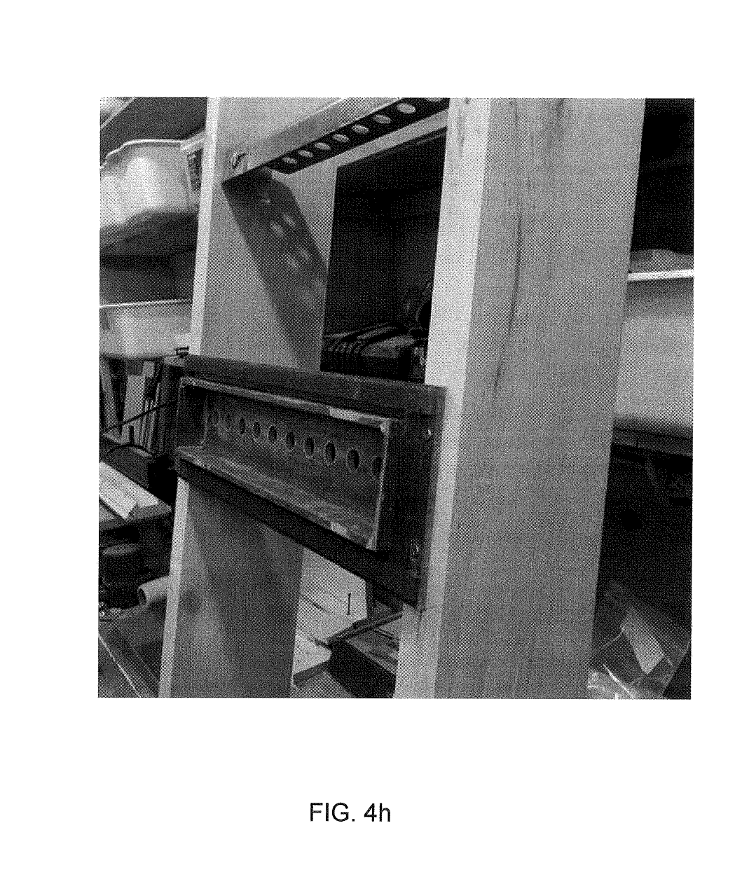

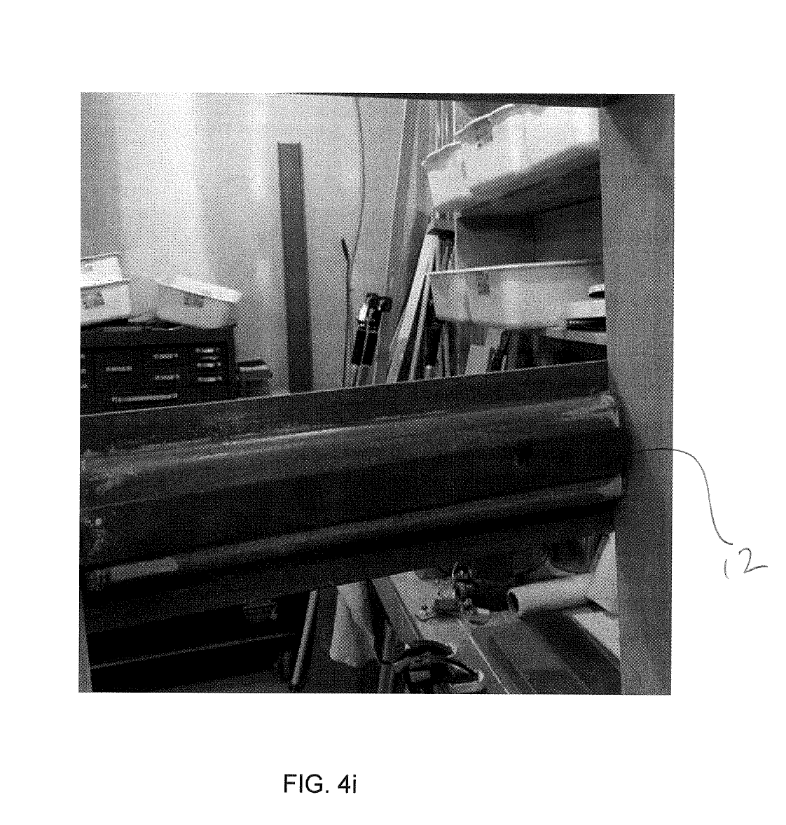

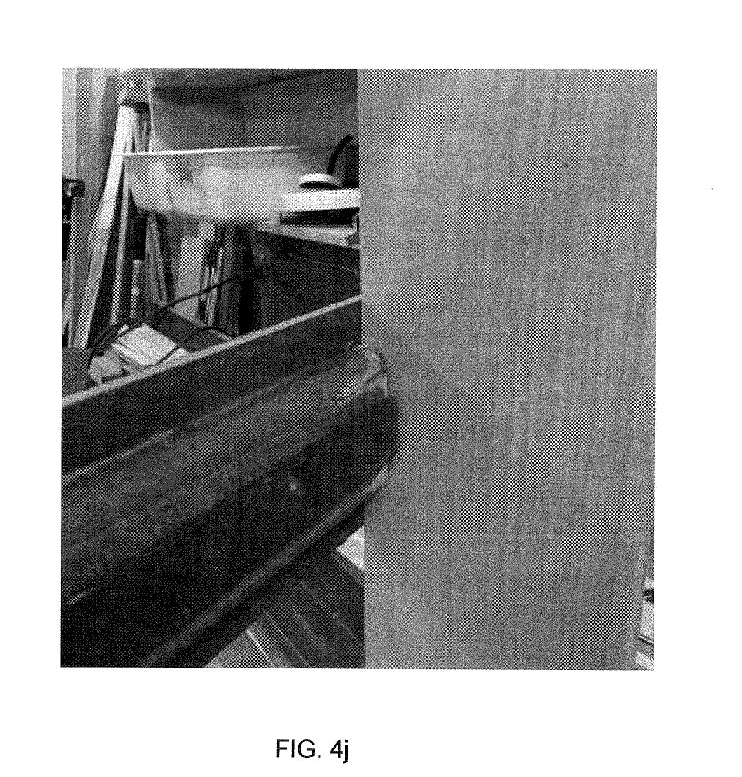

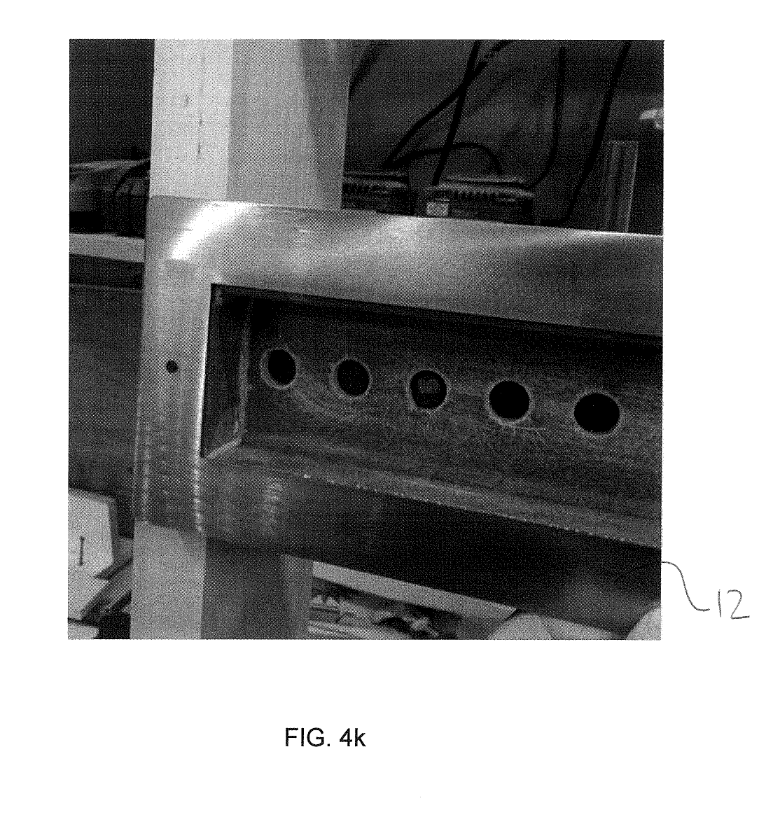

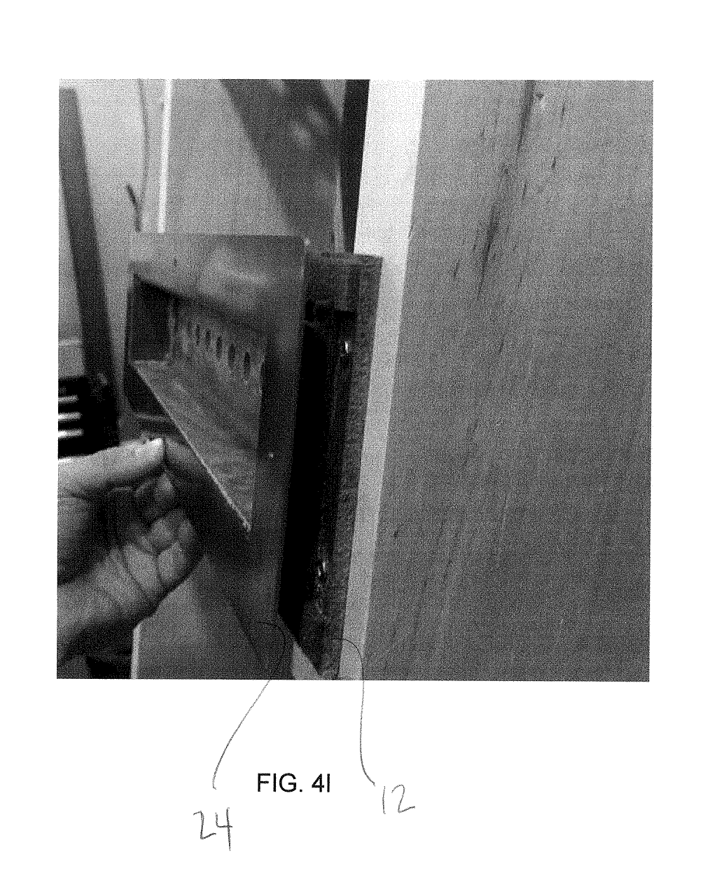

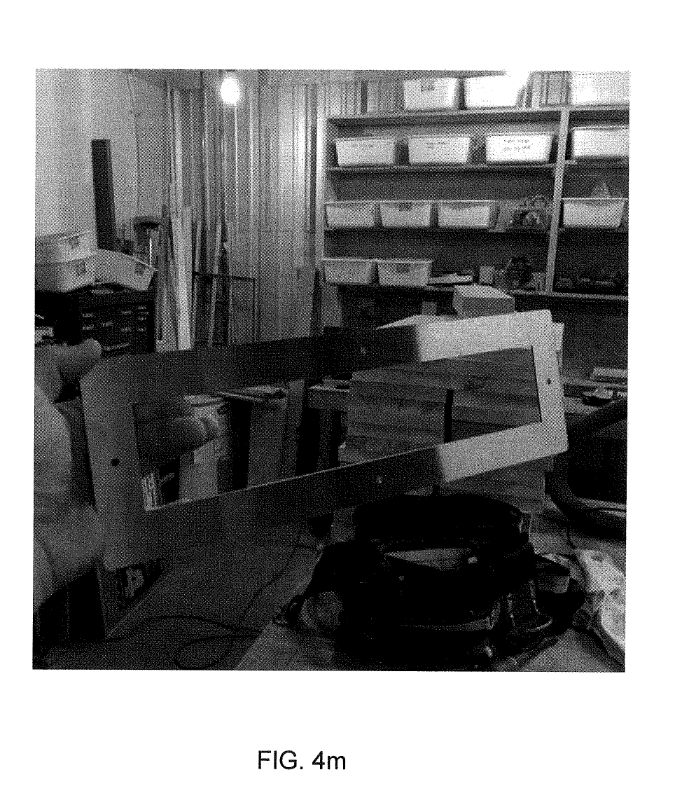

Turning to FIG. 2a, a perspective view of a recessed manager bracket is shown. The recessed manager bracket 30 is preferably mounted between two studs to provide further wire management. This will be shown in more detail with respect to FIGS. 4a to 4l.

The recessed manager bracket 30 includes a set of wire management holes 32 for receiving cables and a set of fastener holes 34 for receiving fasteners associated with a mounting bracket 36 (shown in FIG. 2b). The mounting brackets 36 allow the recessed manager bracket 30 to be mounted between two studs in a house frame. In a preferred embodiment, the recessed manager bracket 30 is mounted between the wall studs in a wall cavity above the wire manager plate (FIG. 1a) in order to bring the cables in line and spaced to meet electrical code as well as keeping the cables forward in the stud space allowing insulation material to be installed behind the bracket 30 and apparatus 10 thereby maintaining a sufficient R-value for the home.

Turning to FIG. 2b, perspective views of an embodiment of a mounting bracket 36 is shown. The mounting bracket 36 preferably includes a set of fastener holes 38 for receiving a fastener for connecting the mounting bracket 36 to a stud and a slot 42 for receiving a fastener 44, such as a carriage bolt 46 and nut 48, for connecting the mounting bracket 36 to the recessed manager bracket 30.

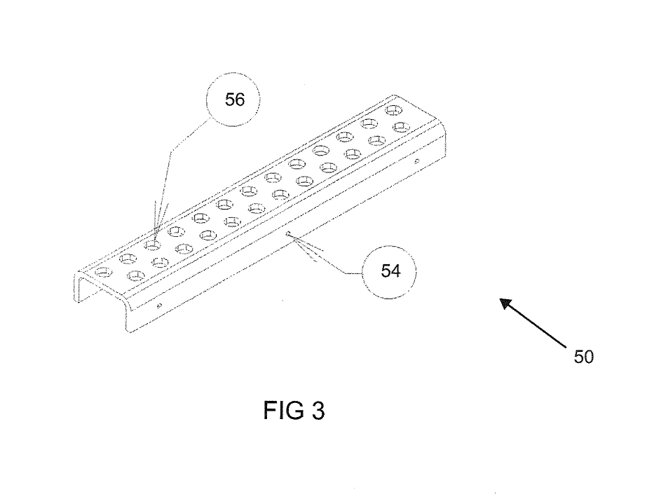

Turning to FIG. 3, a perspective view of a surface mount manager is shown. the surface mount manager 50, is preferably U-shaped, and includes a set of holes 52 for receiving wires or cabling. As can be seen, the set of holes 52 are designed in a double row format. The surface mount manager 50 further includes a set of fastener holes 54 for accommodating a mounting unit (not shown). In some installations, surface mounted cables are required and space is limited above or adjacent to a load center whereby the surface mount manager assists to reduce installation issues or problems. The set of holes 52 allow for the spacing required to keep the cables apart, for safety and code concerns, to be reduced or condensed and to align the cables thereby reducing or eliminating the need for stapling each cable to a stud.

Turning to FIGS. 4a to 4m, a series of photographs showing the apparatus installed between two wall studs is shown. In FIG. 4a, it can be seen that a pair of wire manager plates 12 are installed between a pair of wall studs 60 along with a recessed manager bracket 30 and a surface mount manager 50. FIG. 4b provides a perspective view of the recessed manager bracket 30 and a wire manager plate 12. As can be seen, the slot 42 within the recessed manager bracket 30 allows for alignment of the manager bracket 30 with the mounting bracket 36.

Turning to FIG. 4c, a view of a cable 62 being passed through the surface mount manager 50, the recessed manager bracket 30 and the wire manager plate 12 is shown. As can be seen, the apparatus 10 provides for a way to manage the cables while maintaining adequate spacing to meet electrical codes and to reduce or prevent accidents, such as fires. FIG. 4d provides a further view similar to FIG. 4c.

FIG. 4e provides an enlarged view of a cable passing through the wire manager plate 12. As can be seen the plate 12 is mounted to the wall stud 60 via fasteners 64. The gasket portion can also be seen. As can be seen, the wire management holes 22 are perpendicular to the length of the studs 60.

FIG. 4f provides a rear perspective view of a wire manager plate. As can be seen in FIG. 4f, the cable passes through a rear of the wire manager plate 12 through one of the holes 22 such that it is passed through to the front of the apparatus 10 whereby an installer can access the cable for installation requirements. FIG. 4g is a close-up perspective of the recessed manager bracket. FIG. 4h is another perspective view of the wire manager plate while FIG. 4i is a rear perspective view of a wire manager plate. FIG. 4j is a close-up view of how the apparatus 10 is installed against a wall stud. As can be seen, there is limited or no space between the wire manager and the stud such that leakages are reduced or eliminated. A front view of a wire manager plate having a front plate installed is shown in FIG. 4k while FIG. 4l provides a side view of the same embodiment. FIG. 4m is a perspective view of a front plate.

The above-described embodiments are intended to be examples only. Alterations, modifications and variations can be effected to the particular embodiments by those of skill in the art without departing from the scope of intended protection.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

What is claimed is:

1. Apparatus for managing wiring within a frame of a building, the building including at least two studs within the frame, the apparatus comprising:
a surface mount manager mounted to and between the at least two studs for receiving and spacing electrical cables, the surface mount manager including a set of surface mount manager holes for receiving the electrical cables, the set of surface mount manager holes having an axis parallel to a length of the at least two studs;
a recessed manager bracket mounted to and between the at least two studs for receiving the electrical cables from the surface mount manager, the recessed manager bracket including a set of recessed manager bracket holes for receiving the electrical cables, the set of recessed manager bracket holes having an axis parallel to a length of the at least two studs; and
a wire manager plate apparatus mounted to and between the at least two studs for receiving the electrical cables from the recessed manager bracket, the wire manager plate including a set of wire manager holes for receiving the electrical cables, the set of wire manager plate holes having an axis perpendicular to the length of the at least two studs.

2. The apparatus of claim 1 wherein the wire manager plate apparatus comprises An apparatus for managing electrical wiring comprising:
a wire manager plate including a set of holes for receiving different groupings of electrical wiring; and
a mounting plate including a mounting mechanism for mounting the apparatus to a front of a wall cavity;
wherein the wire manager plate is integrated within the mounting plate.

3. The apparatus of claim 2 wherein the mounting plate forms a lip portion around the wire manager plate.

4. The apparatus of claim 3 wherein the wire manager plate apparatus further comprises a gasket portion affixed to the lip portion.

5. The apparatus of claim 4 wherein the gasket portion is made from foam.

6. The apparatus of claim 2 wherein the wire manager plate apparatus comprises fastener holes.
